(19) United States
(12) Patent Application Publication
(10) Pub. No.: US 2004/0211942 A1
(43) Pub. Date: Oct. 28, 2004

(54) Electrically conductive compositions and method of manufacture thereof

(76) Inventors: Darren Cameron Clark, Pottstown, PA (US); Mark Elkovitch, Clifton Park, NY (US); Soumyadeb Ghosh, Bangalore (IN); Srinivasan Rajagopalan, Bangalore (IN); Sai-Pei Ting, Slingerlands, NY (US)

Correspondence Address: CANTOR COLBURN, LLP, 55 GRIFFIN ROAD SOUTH, BLOOMFIELD, CT, 06002

(21) Appl. No.: 10/818,141

(22) Filed: Apr. 5, 2004

Related U.S. Application Data
(60) Provisional application No. 60/465,994, filed on Apr. 28, 2003.

(51) Int. Cl. H01B 1/00

(52) U.S. Cl. 252/500

(57) ABSTRACT

An electrically conductive composition comprises a polymeric resin; and single wall carbon nanotubes, wherein the composition has an electrical volume resistivity less than or equal to about 10e¹² ohm-cm, a notched Izod impact strength greater than or equal to about 5 kilojoules/square meter. In another embodiment, a method for manufacturing an electrically conductive composition comprises blending a polymeric resin and single wall carbon nanotubes, wherein the composition has an electrical volume resistivity less than or equal to about 10e⁸ ohm-cm, a notched Izod impact strength greater than or equal to about 5 kilojoules/square meter.

### CROSS REFERENCE TO RELATED APPLICATIONS

This application claims the benefit of U.S. Provisional Application Ser. No. 60/465,994, filed Apr. 28, 2003.

### BACKGOUND

This disclosure relates to electrically conductive compositions and methods of manufacture thereof.

Articles made from polymeric resins are commonly utilized in material-handling and electronic devices such as packaging film, chip carriers, computers, printers and photocopier components where electrostatic dissipation or electromagnetic shielding are important requirements. Electrostatic dissipation (hereinafter ESD) is defined as the transfer of electrostatic charge between bodies at different potentials by direct contact or by an induced electrostatic field. Electromagnetic shielding (hereinafter EM shielding) effectiveness is defined as the ratio (in decibels) of the proportion of an electromagnetic field incident upon the shield that is transmitted through it. As electronic devices become smaller and faster, their sensitivity to electrostatic charges is increased and hence it is generally desirable to utilize polymeric resins, which have been modified to provide improved electrostatically dissipative properties. In a similar manner, it is desirable to modify polymeric resins so that they can provide improved electromagnetic shielding while simultaneously retaining some of the advantageous mechanical properties of the polymeric resins.

Conductive fillers such as graphite fibers derived from pitch and polyacrylonitrile having diameters larger than 2 micrometers are often incorporated into polymeric resins to improve the electrical properties and achieve ESD and EM shielding. However, because of the large size of these graphite fibers, the incorporation of such fibers generally causes a decrease in the mechanical properties such as impact. There accordingly remains a need in the art for conductive polymeric compositions, which while providing adequate ESD and EM shielding, can retain their mechanical properties.

### FIGURES

FIG. 1 is a depiction of the various ways in which the graphene sheets are rolled up to produce nanotubes of helical structures. The helical structures may be either of the zigzag or the armchair configuration;

FIG. 2 is a graphical representation of the electrical conductivity of strands containing SWNTs and MWNTs;

FIG. 3 is a graphical representation of the electrical conductivity of strands extruded from semi-crystalline polymers;

FIG. 4 is a graphical representation of the electrical conductivity of strands extruded from amorphous polymers;

FIG. 5 depicts photomicrographs of various sections of microtomed samples taken from the conductive compositions; and

FIG. 6 shows how specific volume resistivity (SVR) varies with electrical conductivity.

### SUMMARY OF THE INVENTION

An electrically conductive composition comprises a polymeric resin; and single wall carbon nanotubes, wherein the composition has an electrical volume resistivity less than or equal to about 10e¹² ohm-cm, a notched Izod impact strength greater than or equal to about 5 kilojoules/square meter.

In one embodiment, an electrically conductive composition comprises a polymeric resin; and multiwall carbon nanotubes, wherein the multiwall carbon nanotubes have a diameter of less than 3.5 nanometers, and wherein the composition has an electrical volume resistivity less than or equal to about 10e¹² ohm-cm, a notched Izod impact strength greater than or equal to about 5 kilojoules/square meter.

In another embodiment, a method for manufacturing an electrically conductive composition comprises blending a polymeric resin and single wall carbon nanotubes, wherein the composition has an electrical volume resistivity less than or equal to about 10e⁸ ohm-cm, a notched Izod impact strength greater than or equal to about 5 kilojoules/square meter.

In another embodiment, an article is manufactured from an electrically conductive composition comprising a polymeric resin and single wall carbon nanotubes.

In yet another embodiment, an article is manufactured by a method comprising blending a polymeric resin and single wall carbon nanotubes.

### DETAILED DESCRIPTION OF THE INVENTION

Disclosed herein are compositions comprising polymeric resins and single wall carbon nanotubes that have a bulk volume resistivity less than or equal to about 10e¹² ohm-cm, while displaying impact properties greater than or equal to about 5 kilojoules/square meter and a Class A surface finish. Disclosed herein too are compositions comprising polymeric resins and single wall carbon nanotubes that have a bulk volume resistivity less than or equal to about 10e⁸ ohm-cm, while displaying impact properties greater than or equal to about 5 kilojoules/square meter and a Class A surface finish. In one embodiment, the composition has a surface resistivity greater than or equal to about 10¹² ohm/square (ohm/sq) while having a bulk volume resistivity less than or equal to about 10e¹² ohm-cm, while displaying impact properties greater than or equal to about 5 kilojoules/square meter and a Class A surface finish. In one embodiment, the composition has a surface resistivity greater than or equal to about 10⁸ ohm/square (ohm/sq) while having a bulk volume resistivity less than or equal to about 10⁸ ohm-cm, while displaying impact properties greater than or equal to about 5 kilojoules/square meter and a Class A surface finish. In one embodiment, the composition has a bulk volume resistivity less than or equal to about 10e⁸ ohm-cm, while displaying impact properties greater than or equal to about 10 kilojoules/square meter and a Class A surface finish. In another embodiment, the composition has a bulk volume resistivity less than or equal to about 10e⁸ ohm-cm, while displaying impact properties greater than or equal to about 15 kilojoules/square meter and a Class A surface finish. Such compositions can be advantageously utilized in computers, electronic goods, semi-conductor components, circuit boards, or the like which need to be protected from electrostatic dissipation. They may also be used advantageously in automotive body panels both for interior and exterior components of automobiles that can be electrostatically painted if desired.

Disclosed herein too are electrically conductive compositions comprising polymeric resins and multiwall carbon nanotubes, wherein the multiwall carbon nanotubes have a diameter of less than 3.5 nanometers (nm), and wherein the composition has a bulk volume resistivity of less than or equal to about 10e¹² ohm-cm, while displaying impact properties greater than or equal to about 5 kilojoules/square meter and a Class A surface finish. The multiwall carbon nanotubes preferably have two, three, four or five walls.

The polymeric resin used in the conductive compositions may be selected from a wide variety of thermoplastic resins, blends of thermoplastic resins, or blends of thermoplastic resins with thermosetting resins. The polymeric resin may also be a blend of polymers, copolymers, terpolymers, or combinations comprising at least one of the foregoing polymeric resins. Specific, but non-limiting examples of thermoplastic resins include polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, and combinations comprising at least one of the foregoing polymeric resins.

Specific non-limiting examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations comprising at least one of the foregoing blends of thermoplastic resins.

The polymeric resin is generally used in amounts of about 5 to about 99.999 weight percent (wt %). Within this range, it is generally desirable to use the polymeric resin or resinous blend in an amount of greater than or equal to about 10 wt %, preferably greater or equal to about 30 wt %, and more preferably greater than or equal to about 50 wt % of the total weight of the composition. The polymeric resins or resinous blends are furthermore generally used in amounts less than or equal to about 99.99 wt %, preferably less than or equal to about 99.5 wt %, more preferably less than or equal to about 99.3 wt % of the total weight of the composition.

Single wall carbon nanotubes (SWNTs) used in the composition may be produced by laser-evaporation of graphite or carbon arc synthesis. These SWNTs generally have a single wall with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the compositions. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In one embodiment, the SWNTs may exist in the form of rope-like-aggregates. These aggregates are commonly termed “ropes” and are formed as a result of Van der Waal's forces between the individual carbon nanotubes. The individual nanotubes in the ropes may slide against one another and rearrange themselves within the rope in order to minimize the free energy. Ropes generally having between 10 and 10⁵ nanotubes may be used in the compositions. Within this range it is generally desirable to have ropes having greater than or equal to about 100, preferably greater than or equal to about 500 nanotubes. Also desirable are ropes having less than or equal to about 10⁴ nanotubes, preferably less than or equal to about 5,000 nanotubes. It is generally desirable to have ropes in the composition with aspect ratios greater than or equal to about 5, preferably greater than or equal to about 10, preferably greater than or equal to about 100, more preferably greater than or equal to about 1000, and most preferably greater than or equal to about 2000. It is generally desirable for the SWNTs to have an inherent thermal conductivity of at least 2000 W/m-K and an inherent electrical conductivity of 10⁴ Siemens/centimeter (S/cm). It is also generally desirable for the SWNTs to have a tensile strength of at least 80 Gigapascals (GPa) and a stiffness of about 0.5 Tarapascals (TPa).

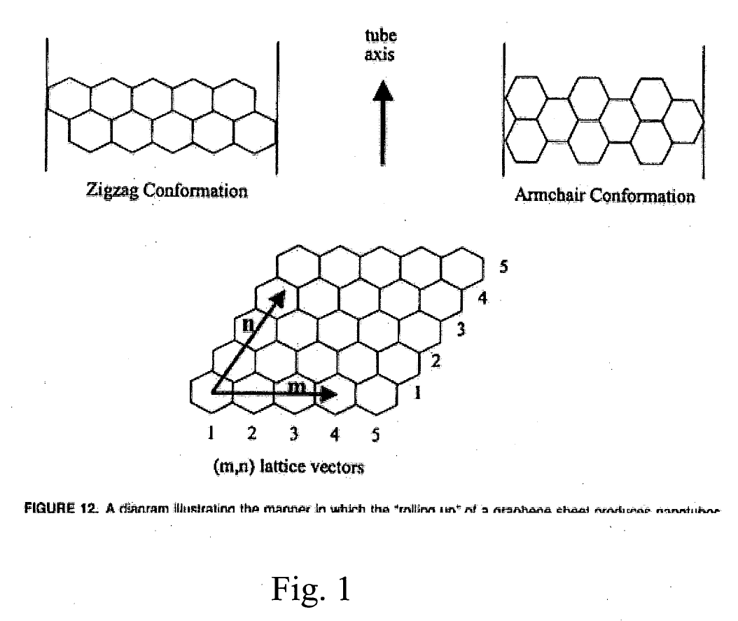

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general, the manner in which the graphene sheet is rolled up produces nanotubes of various helical structures. These structures as well as the lattice vectors is shown in FIG. 1. As may be seen from the FIG. 1, the integer lattice vectors m and n are added together and the tail and head of the resulting vector are placed on top of each other in the final nanotube structure. Zigzag nanotubes have (n,0) lattice vector values, while armchair nanotubes have (n,n) lattice vector values. Zigzag and armchair nanotubes constitute the two possible achiral confirmations, all other (m,n) lattice vector values yield chiral nanotubes. In order to minimize the quantity of SWNTs utilized in the composition, it is generally desirable to have the metallic nanotubes constitute as large a fraction of the total amount of SWNTs used in the composition. It is generally desirable for the SWNTs used in the composition to comprise metallic nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs. In certain situations it may be is generally desirable for the SWNTs used in the composition to comprise semi-conducting nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs.

In one embodiment, the SWNTs used in the composition may not contain any impurities. In yet another embodiment, SWNTs used in the composition may comprise impurities. Impurities are generally obtained as a result of the catalysts used in the synthesis of the SWNTs as well from other non-SWNT carbonaceous by-products of the synthesis. Catalytic impurities are generally metals such as cobalt, iron, yttrium, cadmium, copper, nickel, oxides of metals such as ferric oxide, aluminum oxide, silicon dioxide, or the like, or combinations comprising at least one of the foregoing impurities. Carbonaceous by-products of the reaction are generally soot, amorphous carbon, coke, multiwall nanotubes, amorphous nanotubes, amorphous nanofibers or the like, or combinations comprising at least one of the foregoing carbonaceous by-products.

In general, the SWNTs used in the composition may comprise an amount of about 1 to about 80 wt % impurities. Within this range, the SWNTs may have an impurity content greater than or equal to about 5, preferably greater than or equal to about 7, and more preferably greater than or equal to about 8 wt %, of the total weight of the SWNTs. Also desirable within this range, is an impurity content of less than of equal to about 50, preferably less than or equal to about 45, and more preferably less than or equal to about 40 wt % of the total weight of the SWNTs.

The SWNTs utilized in the composition may also be derivatized with functional groups to improve compatibility and facilitate the mixing with the polymeric resin. The SWNTs may be functionalized on either a sidewall, a hemispherical endcap or on both the side wall as well as the hemispherical endcap. Functionalized SWNTs having the formula (I)

[CₙH_{L}]—Rₘ (I)

wherein n is an integer, L is a number less than 0.1 n, m is a number less than 0.5 n, and wherein each of R is the same and is selected from SO₃H, COOH, NH₂, OH, R′CHOH, CHO, CN, COCl, COSH, SH, COOR′, SR′, SiR₃′, Si—(OR)_{y}—R′_{(3-y)}, R″, AlR₂′, halide, ethylenically unsaturated functionalities, epoxide functionalities, or the like, wherein y is an integer equal to or less than 3, R′ is hydrogen, alkyl, aryl, cycloalkyl, or araalkyl, cycloaryl, poly(alkylether), or the like, R″ is fluoroalkyl, fluoroaryl, fluorocycloalkyl, fluoroaralkyl, cycloaryl, X is halide, and Z is carboxylate, trifluoroacetate, or the like, may be used in the compositions. These compositions are uniform in that each of R is the same.

Non-umiformly substituted SWNTs may also be used in the composition. These include compositions of the formula (I) shown above wherein n, L, m, R and the SWNT itself are as defined above, provided that each of R does not contain oxygen, or, if each of R is an oxygen-containing group, COOH is not present.

Also included in the invention are functionalized nanotubes having the formula (II)

[CₙH_{L}]—[R′—R]ₘ (II)

where n, L, m, R′ and R have the same meaning as above. The carbon atoms, Cₙ, are surface carbons of a SWNT. In both uniformly and non-uniformly substituted SWNTs, the surface atoms Cₙ are reacted. Most carbon atoms in the surface layer of a SWNT are basal plane carbons. Basal plane carbons are relatively inert to chemical attack. At defect sites, where, for example, the graphitie plane fails to extend fully around the SWNT, there are carbon atoms analogous to the edge carbon atoms of a graphite plane. The edge carbons are reactive and must contain some heteroatom or group to satisfy carbon valency.

The substituted SWNTs described above may advantageously be further functionalized. Such compositions include compositions of the formula (III)

[CₙH_{L}]-Aₘ (III)

where the carbons are surface carbons of a SWNT, n, L and m are as described above, A is selected from OY, NHY, —CR′₂—OY, N′Y, C′Y,

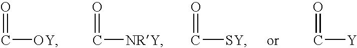

wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from R′OH, R′NH₂, R′SH, R′CHO, R′CN, R′X, R′SiR′₃, RSi—(OR′)_{y}—R′_{(3-y)}, R′Si—(O—SiR′₂)—OR′, R′—R″, R′—N—CO, (C₂H₄O)_{w}—Y, —(C₃H₆O)_{w}—H, —(C₂H₄O)_{w}—R′, —(C₃H₆O)_{w}—R′ and R′, wherein w is an integer greater than one and less than 200.

The functional SWNTs of structure (II) may also be functionalized to produce compositions having the formula (IV)

[CₙH_{L}]—[R′-A]ₘ (IV)

where n, L, m, R′ and A are as defined above. The carbon atoms, Cₙ, are surface carbons of the SWNTs.

The compositions of the invention also include SWNTs upon which certain cyclic compounds are adsorbed. These include compositions of matter of the formula (V)

[CₙH_{L}]—[X—Rₐ]ₘ (V)

where n is an integer, L is a number less than 0.1 n, m is less than 0.5 n, a is zero or a number less than 10, X is a polynuclear aromatic, polyheteronuclear aromatic or metallopolyheteronuclear aromatic moiety and R is as recited above. Preferred cyclic compounds are planar macrocycles as described on p. 76 of Cotton and Wilkinson, Advanced Organic Chemistry. More preferred cyclic compounds for adsorption are porphyrins and phthalocyanines.

The adsorbed cyclic compounds may be functionalized. Such compositions include compounds of the formula (VI)

[CₙH_{L}]—[X-Aₐ]ₘ (VI)

where m, n, L, a, X and A are as defined above and the carbons are on the SWNT.

Without being bound to a particular theory, the functionalized SWNTs are better dispersed into polymeric resins because the modified surface properties may render the SWNT more compatible with the polymeric resin, or, because the modified functional groups (particularly hydroxyl or amine groups) are bonded directly to the polymeric resin as terminal groups. In this way, polymeric resins such as polycarbonates, polyamides, polyesters, polyetherimides, or the like, bond directly to the SWNTs making the SWNTs easier to disperse with improved adherence.

Functional groups may generally be introduced onto the outer surface of the SWNTs by contacting the SWNTs with a strong oxidizing agent for a period of time sufficient to oxidize the surface of the SWNTs and further contacting the SWNTs with a reactant suitable for adding a functional group to the oxidized surface. Preferred oxidizing agents are comprised of a solution of an alkali metal chlorate in a strong acid. Preferred alkali metal chlorates are sodium chlorate or potassium chlorate. A preferred strong acid used is sulfuric acid. Periods of time sufficient for oxidation are about 0.5 hours to about 24 hours.

In general, SWNTs are generally used in amounts of about 0.001 to about 50 wt % of the total weight of the composition. Within this range, it is generally desirable to use SWNTs in an amount of greater than or equal to about 0.025 wt %, preferably greater or equal to about 0.05 wt %, more preferably greater than or equal to about 0.1 wt % of the total weight of the composition. Also desirable are SWNTs in an amount of less than or equal to about 30 wt %, preferably less than or equal to about 10 wt %, more preferably less than or equal to about 5 wt % of the total weight of the composition.

Other conductive fillers such as vapor grown carbon fibers, carbon black, conductive metallic fillers, solid non-metallic, conductive fillers, or the like, or combinations comprising at least one of the foregoing may optionally be used in the compositions. Vapor grown carbon fibers or small graphitic or partially graphitic carbon fibers, also referred to as vapor grown carbon fibers (VGCF), having diameters of about 3.5 to about 2000 nanometers (nm) and an aspect ratio greater than or equal to about 5 may also be used. When VGCF are used, diameters of about 3.5 to about 500 nm are preferred, with diameters of about 3.5 to about 100 nm being more preferred, and diameters of about 3.5 to about 50 nm most preferred. It is also preferable to have average aspect ratios greater than or equal to about 100 and more preferably greater than or equal to about 1000. Representative VGCF are described in, for example, U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al.

VGCF are generally used in amounts of about 0.0001 to about 50 wt % of the total weight of the composition when desirable. Within this range, VGCF are generally used in amounts greater than or equal to about 0.25 wt %, preferably greater or equal to about 0.5 wt %, more preferably greater than or equal to about 1 wt % of the total weight of the composition. VGCF are furthermore generally used in amounts less than or equal to about 30 wt %, preferably less than or equal to about 10 wt %, more preferably less than or equal to about 5 wt % of the total weight of the composition.

Carbon black may also be optionally used, preferred carbon blacks are those having average particle sizes less than about 200 nm, preferably less than about 100 nm, more preferably less than about 50 nm. Preferred conductive carbon blacks may also have surface areas greater than about 200 square meter per gram (m²/g), preferably greater than about 400 m²/g, yet more preferably greater than about 1000 m²/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Exemplary carbon blacks include the carbon black commercially available from Columbian Chemicals under the trade name CONDUCTEX®; the acetylene black available from Chevron Chemical, under the trade names S.C.F. (Super Conductive Furnace) and E.C.F. (Electric Conductive Furnace); the carbon blacks available from Cabot Corp. under the trade names VULCAN XC72 and BLACK PEARLS; and the carbon blacks commercially available from Akzo Co. Ltd under the trade names KETJEN BLACK EC 300 and EC 600. Preferred conductive carbon blacks may be used in amounts from about 2 wt % to about 25 wt % based on the total weight of the composition.

Solid conductive metallic fillers may also optionally be used in the conductive compositions. These may be electrically conductive metals or alloys that do not melt under conditions used in incorporating them into the polymeric resin, and fabricating finished articles therefrom. Metals such as aluminum, copper, magnesium, chromium, tin, nickel, silver, iron, titanium, and mixtures comprising any one of the foregoing metals can be incorporated into the polymeric resin as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin-oxide, indium tin oxide, and the like may also optionally be added to render the polymeric resin conductive. The solid metallic and non-metallic conductive fillers may exist in the form of powder, drawn wires, strands, fibers, tubes, nanotubes, flakes, laminates, platelets, ellipsoids, discs, and other commercially available geometries commonly known in the art.

Non-conductive, non-metallic fillers that have been coated over a substantial portion of their surface with a coherent layer of solid conductive metal may also optionally be used in the conductive compositions. The non-conductive, non-metallic fillers are commonly referred to as substrates, and substrates coated with a layer of solid conductive metal may be referred to as “metal coated fillers”. Typical conductive metals such as aluminum, copper, magnesium, chromium, tin, nickel, silver, iron, titanium, and mixtures comprising any one of the foregoing metals may be used to coat the substrates. Examples of substrates are well known in the art and include those described in “Plastic Additives Handbook, 5^{th} Edition” Hans Zweifel, Ed, Carl Hanser Verlag Publishers, Munich, 2001. Non-limiting examples of such substrates include silica powder, such as fused silica and crystalline silica, boron-nitride powder, boron-silicate powders, alumina, magnesium oxide (or magnesia), wollastonite, including surface-treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, and kaolin comprising various coatings known in the art to facilitate compatibility with the polymeric matrix resin, mica, feldspar, silicate spheres, flue dust, cenospheres, fillite, aluminosilicate (armospheres), natural silica sand, quartz, quartzite, perlite, tripoli, diatomaceous earth, synthetic silica, and mixtures comprising any one of the foregoing. All of the above substrates may be coated with a layer of metallic material for use in the conductive compositions.

Regardless of the exact size, shape and composition of the solid metallic and non-metallic conductive filler particles, they may be dispersed into the polymeric resin at loadings of about 0.0001 to about 50 wt % of the total weight of the composition when desired. Within this range it is generally desirable to have the solid metallic and non-metallic conductive filler particles in an amount of greater than or equal to about 1 wt %%, preferably greater than or equal to about 1.5 wt % and more preferably greater than or equal to about 2 wt % of the total weight of the composition. The loadings of said solid metallic and non-metallic conductive filler particles may be less than or equal to 40 wt %, preferably less than or equal to about 30 wt %, more preferably less than or equal to about 25 wt % of the total weight of the composition.

The polymeric resin together with the SWNTs and any other optionally desired conductive fillers such as the VGCF, carbon black, solid metallic and non-metallic conductive filler particles may generally be processed in several different ways such as, but not limited to melt blending, solution blending, or the like, or combinations comprising at least one of the foregoing methods of blending. Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Melt blending involving the aforementioned forces may be conducted in machines such as, but not limited to single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines. It is generally desirable during melt or solution blending of the composition to impart a specific energy of about 0.01 to about 10 kilowatt-hour/kilogram (kwhr/kg) of the composition. Within this range, a specific energy of greater than or equal to about 0.05, preferably greater than or equal to about 0.08, and more preferably greater than or equal to about 0.09 kwhr/kg is generally desirable for blending the composition. Also desirable is an amount of specific energy less than or equal to about 9, preferably less than or equal to about 8, and more preferably less than or equal to about 7 kwhr/kg for blending the composition.

In one embodiment, the polymeric resin in powder form, pellet form, sheet form, or the like, may be first dry blended with the SWNT and other optional fillers if desired in a Henschel or a roll mill, prior to being fed into a melt blending device such as an extruder or Buss kneader. While it is generally desirable for the shear forces in the melt blending device to generally cause a dispersion of the SWNTs in the polymeric resin, it is also desired to preserve the aspect ratio of the SWNTs during the melt blending process. In order to do so, it may be desirable to introduce the SWNTs into the melt blending device in the form of a masterbatch. In such a process, the masterbatch may be introduced into the melt blending device downstream of the polymeric resin.

A melt blend is one where at least a portion of the polymeric resin has reached a temperature greater than or equal to about the melting temperature, if the resin is a semi-crystalline polymeric resin, or the flow point (e.g., the glass transition temperature) if the resin is an amorphous resin during the blending process. A dry blend is one where the entire mass of polymeric resin is at a temperature less than or equal to about the melting temperature if the resin is a semi-crystalline polymeric resin, or at a temperature less than or equal to the flow point if the polymeric resin is an amorphous resin and wherein polymeric resin is substantially free of any liquid-like fluid during the blending process. A solution blend, as defined herein, is one where the polymeric resin is suspended in a liquid-like fluid such as, for example, a solvent or a non-solvent during the blending process.

When a masterbatch is used, the SWNTs may be present in the masterbatch in an amount of about 1 to about 50 wt %. Within this range, it is generally desirable to use SWNTs in an amount of greater than or equal to about 1.5 wt %, preferably greater or equal to about 2 wt %, more preferably greater than or equal to about 2.5 wt % of the total weight of the masterbatch. Also desirable are SWNTs in an amount of less than or equal to about 30 wt %, preferably less than or equal to about 10 wt %, more preferably less than or equal to about 5 wt % of the total weight of the masterbatch. In one embodiment pertaining to the use of masterbatches, while the masterbatch containing the SWNTs may not have a measurable bulk or surface resistivity either when extruded in the form of a strand or molded into the form of dogbone, the resulting composition into which the masterbatch is incorporated has a measurable bulk or surface resistivity, even though the weight fraction of the SWNTs in the composition is lower than that in the masterbatch. In another embodiment pertaining to the use of masterbatches, the masterbatch containing the SWNTs may have a higher measurable bulk or surface resistivity than that of the conductive composition into which the masterbatch is incorporated. Examples of semi-crystalline polymeric resins which display these characteristics and which may be used in masterbatches are polypropylene, polyamides, polyesters, or the like, or combinations comprising at least on of the foregoing semi-crystalline polymeric resins.

In another embodiment relating to the use of masterbatches in polymeric blends, it is sometimes desirable to have the masterbatch comprising a polymeric resin that is the same as the polymeric resin that forms the continuous phase of the composition. This feature permits the use of substantially smaller proportions of the SWNTs, since only the continuous phase carries the SWNTs that provide the composition with the requisite volume and surface resistivity. In yet another embodiment relating to the use of masterbatches in polymeric blends, it may be desirable to have the masterbatch comprising a polymeric resin that is different in chemistry from other the polymeric that are used in the composition. In this case, the polymeric resin of the masterbatch will form the continuous phase in the blend.

The composition comprising the polymeric resin and the SWNTs may be subject to multiple blending and forming steps if desirable. For example, the composition may first be extruded and formed into pellets. The pellets may then be fed into a molding machine where it may be formed into other desirable shapes such as housing for computers, automotive panels that can be electrostatically painted, or the like. Alternatively, the composition emanating from a single melt blender may be formed into sheets or strands and subjected to post-extrusion processes such as annealing, uniaxial or biaxial orientation.

In one embodiment, the composition after melt blending preferably contains the SWNT's in the form of a SWNT network. The SWNT network is preferably a three-dimensional network and facilitates the passage of an electric current through the composition. Electron tunneling may also occur between SWNT's present in the network. Electron tunneling may also occur between the SWNT's and other conductive particles (e.g., carbon black, MWNTs, or the like) in the network. The SWNT network comprises nodes at which either the individual SWNT's or the SWNT ropes make physical contact.

The SWNT network may be characterized as having a fractal structure. Fractals display self-similarity at different levels of magnification, i.e., they display dilatational symmetry. Fractals may be mass or surface fractals. It is desirable for the SWNT network to display the characteristics similar to a mass fractal. In a mass fractal, the mass M of the network scales with a characteristic dimension (such as the radius of gyration R_{g}) to a fractional power x as shown in the equation (1) below.

M˜<R_{g}>^{x} (1)

For mass fractals, the value of x is from 0 to 3. A value of less than or equal to about 2 generally represents an open or ramified network, while a value close to 3 represents a compact network. In general it is desirable for the SWNT network to have a value of x of less than or equal to about 2.5, preferably less than or equal to about 2, preferably less than or equal to about 1.75, and more preferably less than or equal to about 1.6.

As noted above, it is desirable for the network to have nodes at which the SWNT's are in physical contact with each other or close enough for electron tunneling to take place. For an electrically conductive network, it is generally desirable to have as many nodes as possible within a square micrometer. In general, it is desirable for the conductive composition to have an amount of greater than or equal to about 5 nodes/square micrometer, preferably greater than or equal to about 20 nodes/square micrometer, more preferably greater than or equal to about 50 nodes/square micrometer, and most preferably greater than or equal to about 100 nodes/square micrometer. As will be seen, the number of nodes and hence the electrical conductivity of the composition can be increased by thermal annealing.

In one embodiment, the number of nodes may also be increased by varying the injection molding conditions. In one embodiment, the network may be improved (i.e., the nodes may be increased with a consequent improvement in electrical conductivity) by increasing the injection molding speed. In another embodiment, the network may be improved by increasing the residence time of the melt in the mold. In yet another embodiment, the network may be improved by increasing the temperature of the mold.

In one embodiment involving the use of post-processing, the melt blended composition is further subjected to ultradrawing in the unaxial direction utilizing draw ratios of about 2 to about 1,000,000. The high ultradraw ratios generally facilitates the formation of shish-kebab semi-crystalline structures, which may contain SWNTs in the amorphous regions. In another embodiment, the composition is further stressed uniaxially or biaxially to produce a film having a thickness of about 0.01 micrometers to about 5000 micrometers. If the film comprises a semi-crystalline polymeric resin, it is generally desirable for the oriented film to have crystals oriented in the azimuthal direction of about θ=0 degrees to about θ=80 degrees. In yet another embodiment related to post-processing after melt blending, the composition is supercooled to a temperature of about 1° C. to about 100° C. below the melting point after the blending for a time period of about 2 minutes to about 2 hours. The supercooled compositions may generally have macroscopic semi-crystalline structures such as spherulites, which comprise SWNTs.

In another embodiment related to post processing, the conductive composition can have its ability to conduct electricity improved by thermal annealing. Without being limited to theory, it is believed that by annealing the composition at a temperature greater than the glass transition temperature of the organic polymer, a minor rearrangement of the SWNT's within the conductive composition occurs, which improves the structure of the network and hence increases the ability of the composition to conduct electricity.

In semi-crystalline polymers, the SWNTs may behave as nucleating agents. In order to improve the strength of the composition, it may be desirable to have the crystallites nucleate on the SWNTs. In, general it is desirable to have at least 1 wt %, preferably at least 10 wt %, and more preferably at least 15 wt % of the crystallites nucleate on the SWNTs. It is generally desirable for the enthalpy of melting of the composition to be greater than or equal to about 0.2 Joules/mole-Kelvin (J/mol⁻¹-K⁻¹), preferably greater than or equal to about 3, and more preferably greater than or equal to about 0.5 J/mol⁻¹-K⁻¹ when measured in a differential scanning calorimeter at a rate greater than or equal to about 2° C./minute.

Solution blending may also be used to manufacture the composition. The solution blending may also use additional energy such as shear, compression, ultrasonic vibration, or the like to promote homogenization of the SWNTs with the polymeric resin. In one embodiment, a polymeric resin suspended in a fluid may be introduced into an ultrasonic sonicator along with the SWNTs. The mixture may be solution blended by sonication for a time period effective to disperse the SWNTs onto the polymeric resin particles. The polymeric resin along with the SWNTs may then be dried, extruded and molded if desired. It is generally desirable for the fluid to swell the polymeric resin during the process of sonication. Swelling the polymeric resin generally improves the ability of the SWNTs to impregnate the polymeric resin during the solution blending process and consequently improves dispersion.

In another embodiment related to solution blending, the SWNTs are sonicated together with polymeric resin precursors. Polymeric resin precursors are generally monomers, dimers, trimers, or the like, which can be reacted into polymeric resins. A fluid such as a solvent may optionally be introduced into the sonicator with the SWNTs and the polymeric resin precursor. The time period for the sonication is generally an amount effective to promote encapsulation of the SWNTs by the polymeric resin precursor. After the encapsulation, the polymeric resin precursor is then polymerized to form a polymeric resin within which is dispersed the SWNTs. This method of dispersion of the SWNTs in the polymeric resin promotes the preservation of the aspect ratios of the SWNTs, which therefore permits the composition to develop electrical conductivity at lower loading of the SWNTs.

Suitable examples of monomers that may be used to facilitate this method of encapsulation and dispersion are those used in the synthesis of thermoplastic resins such as, but not limited to polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, or the like. In general, it is desirable to sonicate the mixture of polymeric resin, polymeric resin precursor, fluid and/or the SWNTs for a period of about 1 minute to about 24 hours. Within this range, it is desirable to sonicate the mixture for a period of greater than or equal to about 5 minutes, preferably greater than or equal to about 10 minutes and more preferably greater than or equal to about 15 minutes. Also desirable within this range is a time period of less than or equal to about 15 hours, preferably less than or equal to about 10 hours, and more preferably less than or equal to about 5 hours.

The compositions described above may be used in a wide variety of commercial applications. They may be advantageously utilized as films for packaging electronic components such as computers, electronic goods, semi-conductor components, circuit boards, or the like which need to be protected from electrostatic dissipation. They may also be used internally inside computers and other electronic goods to provide electromagnetic shielding to personnel and other electronics located outside the computer as well as to protect internal computer components from other external electromagnetic interference. They may also be used advantageously in automotive body panels both for interior and exterior components of automobiles that can be electrostatically painted if desired.

The following examples, which are meant to be exemplary, not limiting, illustrate compositions and methods of manufacturing of some of the various embodiments of the electrically conductive compositions described herein.

### EXAMPLE 1

In this example, a comparison was made between SWNTs commercially obtained from Carbon Nanotechnologies Incorporated (CNI) or Nanoledge SA, and multiwall nanotubes (MWNTs) commercially obtained from Hyperion Catalysts Incorporated.

The SWNTs obtained from CNI were in the form of Bucky Pearls, which are a compacted form of SWNTs. The Bucky Pearls obtained from CNI contain either 10 wt % or 29 wt % impurities respectively. The SWNTs obtained from Nanoledge contained either 30 wt % or 50 wt % impurities. The SWNTs were first sonicated in chloroform for a period of 30 minutes at room temperature in order to de-agglomerate and de-compact them. A polycarbonate resin was then added to the SWNT-chloroform mixture in the sonicator and the sonication was then continued for another 30 minutes. The mixture was then dried overnight and the resulting paste was extruded in a DACA mini twin screw extruder to form a strand. The DACA mini twin screw extruder has a maximum mixing volume of 5 cubic centimeters and has a screw speed of from about 10 to about 360 rpm which is digitally controllable in 1 rpm increments.

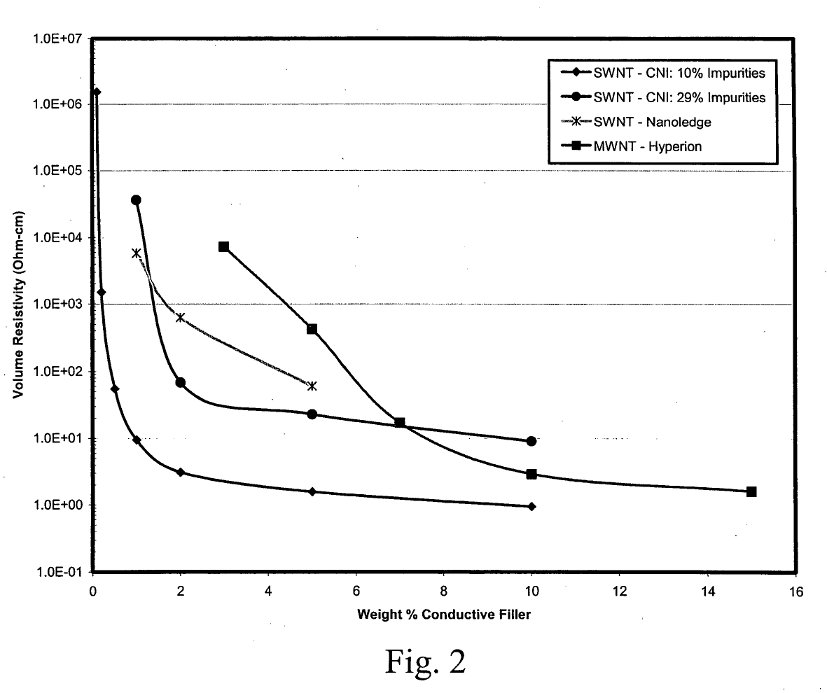

The MWNTs were obtained in a polycarbonate masterbatch having 15 wt % MWNTs from Hyperion. The masterbatch was then directly compounded with the remaining polymeric resin in the DACA mini twin-screw extruder to form a strand. The conductivity on these strands was measured in the same manner as detailed above. The results shown in the FIG. 2 clearly show that the results obtained with the compositions containing SWNTs is superior to those obtained for compositions containing MWNTs. In general it may be seen that the SWNTs produce measurable electrical conductivity at wt % of as low as 0.1 wt % in the polymeric resin, where the wt % are measured with respect to the total composition. The MWNTs on the other hand do not produce any measurable electrical conductivity at wt % of less than 3 wt %. From the figure it may also be seen that the SWNTs that contain lower amounts of impurities generally have a lower resistivity. The SWNT batch having 10% impurities displays an electrical volume resistivity of about 1.2e⁵ ohm-cm. Thus purer SWNT batches produce better electrical conductivity.

### EXAMPLE 2

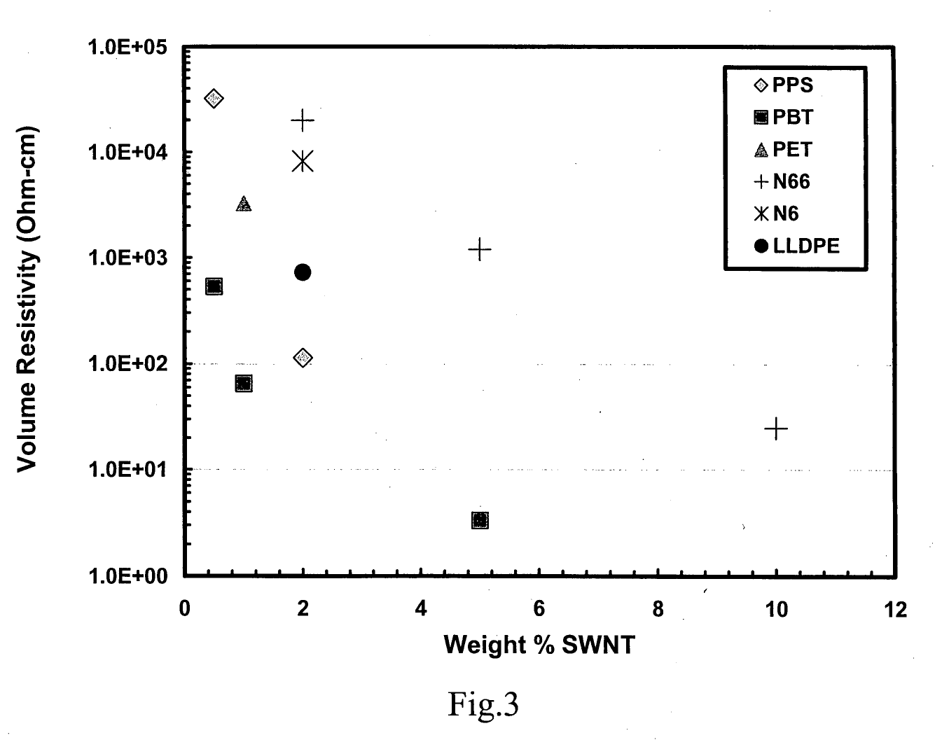

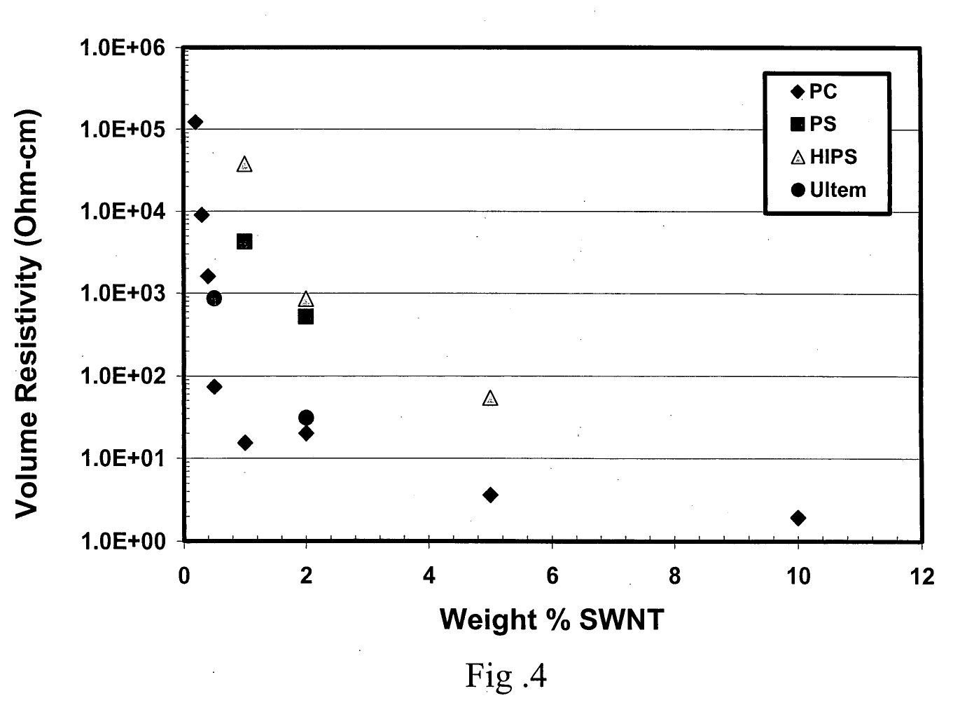

This example was conducted to demonstrate the effect of incorporation of SWNTs into different polymeric resins. SWNTs obtained from CNI containing 10 wt % impurities were ultrasonicated to facilitate the dispersion of the SWNTs. The solution containing the SWNTs was then blended with either crystalline resins or amorphous resins (in the form of powder particles) and subjected to drying. Upon drying, the SWNTs were deposited on the surface of the crystalline or amorphous resins. The crystalline or amorphous resins with the SWNTs deposited upon them were then extruded in the manner detailed in Example 1. The results obtained for blending with the following crystalline resins—polyphenylene sulfide (PPS), polybutylene terephthalate (PBT), polyethylene terephthalate (PET), nylon 6,6 (N66), nylon 6 (N6) and linear low-density polyethylene (LLDPE) are shown in FIG. 3, while the results obtained for blending with the following amorphous resins—polycarbonate (PC), polystyrene (PS), high impact polystyrene (HIPS) and polyetherimide (Ultem) are shown in FIG. 4.

### EXAMPLE 3

In this example, conductive compositions were obtained by first melt blending the MWNTs and the SWNTs (containing 29 wt % impurities) to form a 10 wt % masterbatch with nylon 6,6, following which the masterbatches were melt blended with a polyphenylene ether-polyamide blend in a 16 millimeter (mm) Prism twin screw extruder. The masterbatches were produced at a temperature of 250° C., a screw speed of 300 rpm, and at a rate of 10 lbs/hour. The masterbatch strands emanating from the 16 mm extruder were then pelletized. It was noticed that the masterbatch strand containing the SWNTs had a very rough surface while the masterbatch pellet containing the MWNTs had a very smooth surface. Without being limited by theory, this may indicate that the SWNTs behave in a fundamentally different manner from the MWNTs when compounded into a masterbatch and are more difficult to uniformly disperse within the polymeric resin because of their larger surface areas.

The polyamide used in the polyphenylene ether-polyamide blend was nylon 6,6. The polyphenylene ether polyamide blend was first compounded on a 30 mm Werner and Pfleiderer twin screw extruder at 290° C. The screw speed was maintained at 350 rpm and the blend was produced at 50 lbs/hr.

The polyphenylene ether along with the other ingredients shown in Table 1 were fed into the throat of a 16 mm Prism twin screw extruder to produce a polyphenylene ether-polyamide blend having carbon nanotubes. The polyphenylene ether-polyamide blend having carbon nanotubes were produced at a temperature of 250° C., a screw speed of 300 rpm, and at a rate of 10 lbs/hour.

The extrudate from the 16 mm Prism twin screw extruder was then pelletized and subjecting to molding in a Boy 15 Ton press (injection molding machine) to form only ASTM Izod bars. The temperature in the cylinder of the Boy 15 Ton press was maintained at 298° C. while the temperature in the mold was maintained at 76° C. The Izod bars were used to measure impact strength as per ASTM D 256 as well as the specific volume resistivity (SVR) of the samples. The SVR of the samples was measured by cold fracturing the ends of the Izod bar under liquid nitrogen. After drying the bar, the ends were painted with conductive silver paint and the resistivity measured using a Fluke multimeter. Five samples were measured and the average values are reported in the Table 2. From these results it may be seen that there is no specific volume resistivity for samples containing 0.4 and 0.8 wt % of the SWNTs. For the samples containing 1.2 wt % nanotubes, the sample containing the SWNT shows a whole order of magnitude improvement in electrical conductivity over the sample containing the MWNTs despite the difficulty in dispersing them in a 16 millimeter twin screw extruder.

TABLE 1

| | Polyphenylene | Citric | Cupric | Irganox | Potassium | Kraton G | Kraton G | Nylon 6,6 |
|---|---|---|---|---|---|---|---|---|
| Sample # | ether | Acid | Iodide | 1076 | Iodide | 1651 | 1701X | (downstream) |
| 1 | 38.54 | 0.65 | 0.01 | 0.30 | 0.10 | 7.00 | 3.5 | 46.27 |
| 2 | 38.54 | 0.65 | 0.01 | 0.30 | 0.10 | 7.00 | 3.5 | 42.67 |
| 3 | 38.54 | 0.65 | 0.01 | 0.30 | 0.10 | 7.00 | 3.5 | 39.07 |
| 4 | 38.54 | 0.65 | 0.01 | 0.30 | 0.10 | 7.00 | 3.5 | 46.27 |
| 5 | 38.54 | 0.65 | 0.01 | 0.30 | 0.10 | 7.00 | 3.5 | 42.67 |
| 6 | 38.54 | 0.65 | 0.01 | 0.30 | 0.10 | 7.00 | 3.5 | 39.07 |

TABLE 2

| Sample # | Nylon 6,6 | MWNT | SWNT |
|---|---|---|---|
| 1 | 39.87 | 0.60 | — |
| 2 | 39.87 | 0.90 | — |
| 3 | 39.87 | 1.20 | — |
| 4 | 39.87 | — | 0.60 |
| 5 | 39.87 | — | 0.90 |
| 6 | 39.87 | — | 1.20 |

TABLE 3

| | | | Specific | Notched | Melt |
|---|---|---|---|---|---|
| | | | volume | Izod | Viscosity |
| Sam- | | | resistivity | (kilojoules/ | (Pa-s) @ |
| ple # | MWNT(%) | SWNT(%) | (kohm-cm) | m²) | 282° C. |
| 1 | 1.2 | — | 23 | 23.1 | 258 |
| 2 | 0.8 | — | — | 23.4 | 249 |
| 3 | 0.4 | — | — | 23.3 | 223 |
| 4 | — | 1.2 | 2 | 16.7 | 248 |
| 5 | — | 0.8 | — | 19.3 | 237 |
| 6 | — | 0.4 | — | 16.7 | 209 |

This example was undertaken to determine the differences in performance between masterbatches made from MWNTs and SWNTs when such masterbatches are made under high shear conditions, such as for example on a 30 mm Werner and Pfleiderer twin-screw extruder. In this example masterbatches comprising 3 wt % of either MWNTs or SWNTs was first extruded on the twin screw extruder. The masterbatch containing the SWNTs was non conductive while the masterbatch containing the MWNTs displayed a specific volume resistivity of about 19.1 kohm-cm. The 3 wt % masterbatch was then reduced by mixing with additional nylon 6,6 in a 30 mm Werner and Pfleiderer twin screw extruder to form and intermediate conductive composition. The intermediate compositions are shown in Table 4. The polyphenylene ether-polyamide blends shown in Table 5 was extruded in a separate run on the 30 mm twin screw extruder. The final polyphenylene polyamide compositions were derived by extruding the respective compositions from Table 4 with those from Table 5. For example, Sample 7 from Table 4 was blended with sample 7 from Table 5 to give a composition that yielded the results for Sample 7 seen in Table 6.

The conditions utilized on the 30 mm Werner and Pfleiderer twin screw extruder for the preparation of the masterbatches were a barrel temperature of 250° C. a screw speed of 350 rpm with an output of 50 lbs/hr. The extruder conditions used for the preparation of the polyphenylene ether-polyamide blend as well as the polyphenylene ether-polyamide blend containing the nanotubes were a barrel temperature of 290° C., a screw speed of 350 rpm with an output of 50 lbs/hr. The electrical properties of the polyphenylene ether-polyamide blend containing the nanotubes are shown in Table 6. From Table 6 it can be seen that while the samples containing the MWNT do not display any electrical conductivity, the samples having the SWNTs do show electrical conductivity.

TABLE 4

| Sample # | Nylon 6,6 | MWNT | SWNT |
|---|---|---|---|
| 7 | 39.87 | 0.60 | — |
| 8 | 39.87 | 0.90 | — |
| 9 | 39.87 | 1.20 | — |
| 10 | 39.87 | — | 0.60 |
| 11 | 39.87 | — | 0.90 |
| 12 | 39.87 | — | 1.20 |

TABLE 5

| | Polyphenylene | Citric | Cupric | Irganox | Potassium | Kraton G | Kraton G | Nylon 6,6 |
|---|---|---|---|---|---|---|---|---|
| Sample # | ether | Acid | Iodide | 1076 | Iodide | 1651 | 1701X | (downstream) |
| 7 | 38.54 | 0.65 | 0.01 | 0.30 | 0.10 | 7.00 | 3.5 | 10.00 |
| 8 | 38.54 | 0.65 | 0.01 | 0.30 | 0.10 | 7.00 | 3.5 | 10.00 |
| 9 | 38.54 | 0.65 | 0.01 | 0.30 | 0.10 | 7.00 | 3.5 | 10.00 |
| 10 | 38.54 | 0.65 | 0.01 | 0.30 | 0.10 | 7.00 | 3.5 | 10.00 |
| 11 | 38.54 | 0.65 | 0.01 | 0.30 | 0.10 | 7.00 | 3.5 | 10.00 |
| 12 | 38.54 | 0.65 | 0.01 | 0.30 | 0.10 | 7.00 | 3.5 | 10.00 |

TABLE 6

| | | | Specific | Notched | Melt |
|---|---|---|---|---|---|
| | | | volume | Izod | Viscosity |
| Sam- | | | resistivity | (kilojoules/ | (Pa-s) @ |
| ple # | MWNT(%) | SWNT(%) | (kohm-cm) | m²) | 282° C. |
| 7 | 0.6 | — | 0L | | |
| 8 | 0.9 | — | 0L | 23.8 | 218 |
| 9 | 1.2 | — | 0L | 27.5 | 214 |
| 10 | — | 0.6 | 441 | 26.5 | 214 |
| 11 | — | 0.9 | 156 | 23.8 | 232 |
| 12 | — | 1.2 | 38 | 17.0 | 235 |

These results clearly show that the masterbatches containing the SWNTs behave differently from those containing the MWNTs. From the results it may be seen that while the masterbatch containing the SWNTs are not conductive, the polyphenylene ether-polyamide blends containing the SWNTs are conductive. This is contrast to the polyphenylene ether-polyamide blends containing the MWNTs, which are non-conductive, while the masterbatches from which these blends are made are indeed conductive. Without being limited to theory, it is surmised that the additional shear that occurs in the extruder when the higher viscosity polyphenylene-ether polyamide blend is compounded with the masterbatch, promotes the disentangling of the single wall nanotubes thereby improving electrical conductivity. However, with the MWNTs it is believed that this additional shear promotes a reduction in the aspect ratio, which degrades the electrical conductivity of the samples. It is surmised that the larger diameters of the MWNTs may facilitate their reduction in size when subjected to the shear forces in the extruder.

### EXAMPLE 5

This example demonstrates the effect of shear and as well as the effects of impurities on the level of conductivity that may be attained when SWNTs are blended with thermoplastic resins. In this example, a polycarbonate resin having a number average molecular weight of about 17,000 grams/mole and a weight average molecular weight of Mw˜41,000 was blended with 1 wt % of SWNTs in the DACA mini twin screw extruder. The SWNTs contained either 3 wt % or 10 wt % impurities. The extruder screw speed was adjusted to be either 75, 150 or 300 rpm. The extruder temperature was 285° C. The conductivity of the extruded samples was measured at mixing intervals of 1, 3, 5, 7, and 10 minutes. The mixing intervals of about 1 to about 2 minutes are similar to the residence time of the melt in the extruder and hence no samples were obtained and measured at these times intervals. The extruded strands were then used for electrical specific volume resistivity measurements and are expressed in ohm-cm. SVR measurements are shown in Tables 7 and 8 for the blends containing 3 and 10 wt % impurities respectively. Table 7

TABLE 7

| | Mixing Time | | | | |
|---|---|---|---|---|---|
| RPM | 1 min | 3 min | 5 min | 7 min | 10 min |
| 75 | 15,298 | 10,718 | 7,744 | 13,529 | 13,294 |
| 150 | 7,353 | 6,550 | 37,918 | 70,782 | 91,215 |
| 300 | 6,626 | 5,555 | 101,088 | — | — |

TABLE 8

| | Mixing Time | | | | |
|---|---|---|---|---|---|
| RPM | 1 min | 3 min | 5 min | 7 min | 10 min |
| 75 | — | — | — | 43,372 | 29,373 |
| 150 | — | 494,381 | 44,706 | 48,851 | 90,673 |
| 300 | — | 26,420 | 4,365 | 6,387 | 37,188 |

As may be seen from the Tables 7 and 8, samples having a smaller weight percentages of impurities, generally utilize less mixing in order to display conductivity. The results also indicate that the higher the level of impurities in a given composition, the more difficult it will be to achieve electrical performance in a commercially viable manner. It can also be seen that as the amount of mixing is increased, there is generally first a increase in the level of conductivity followed by a decrease, indicating that with increased mixing, the conductive SWNTs are being separated from each other. In other words, without being limited by theory, it may be postulated that there is an optimum level of energy that needs to be imparted to a given composition in order to obtain the lowest resistivity.

### EXAMPLE 6

This experiment was conducted to determine the effect of mixing on the molecular weight of the resin and on the SVR of the resulting blend. In this example, a polycarbonate resin was blended with 1 wt % of SWNTs in the DACA mini twin screw extruder for time periods of about 1 minute to about 10 minutes. The compositions as well as the method of manufacture were similar to those used in Example 5. The test methods employed were similar to those detailed above. The number (Mₙ) and weight average (M_{w}) molecular weights of the polycarbonate were measured by GPC and are shown in Tables 9 and 10 below.

TABLE 9

| | | | % | | % | |
|---|---|---|---|---|---|---|
| Time | Impurities | | decrease | | decrease | SVR |
| (min) | (%) | Mₙ | in Mₙ | M_{w} | in M_{w} | (ohm-cm) |
| 0 | Pure PC | 17,136 | — | 41,609 | — | — |
| 1 | 10 | 15,943 | 7.0 | 39,126 | 6.0 | — |
| 3 | 10 | 14,631 | 14.6 | 35,854 | 13.8 | 494,381 |
| 5 | 10 | 14,413 | 15.9 | 35,587 | 14.5 | 44,706 |
| 7 | 10 | 14,070 | 17.9 | 34,396 | 17.3 | 49,851 |
| 10 | 10 | 13,808 | 19.4 | 33,964 | 18.4 | 90,763 |

TABLE 10

| | | | % | | % | |
|---|---|---|---|---|---|---|
| Time | Impurities | | decrease | | decrease | SVR |
| (min) | (%) | Mₙ | in Mₙ | M_{w} | in M_{w} | (ohm-cm) |
| 0 | Pure PC | 17,136 | — | 41,609 | — | — |
| 1 | 3 | 14,979 | 12.6 | 36,282 | 12.8 | 7,353 |
| 3 | 3 | 14,802 | 13.6 | 35,822 | 13.9 | 6,550 |
| 5 | 3 | 14,110 | 17.7 | 33,788 | 18.8 | 37,918 |
| 7 | 3 | 13,740 | 19.8 | 32,839 | 21.1 | 70,782 |
| 10 | 3 | 13,509 | 21.2 | 32,128 | 22.8 | 91,215 |

From Tables 9 and 10 above, it may be seen that the compositions having the SWNTs with 3 wt % impurities, generally show appreciable conductivity with very small amounts of mixing. From the tables it can also be seen that for comparable amounts of degradation in molecular weight during the blending process, the sample containing the lesser impurities develops a greater electrical conductivity than the sample containing a higher amount of electrical conductivity. Thus, by choosing an appropriate level of impurity for a given composition, it is possible to develop a desirable level of electrical conductivity while minimizing the degradation of physical properties of the polymeric resin.

As may be seen from the above examples, the composition comprising SWNTs display superior properties to those comprising MWNTs. The compositions comprising SWNTs generally have a notched Izod impact greater than 5 kilojoules/square meter (kjoules/m²), preferably greater than or equal to about 10 kjoules/m², more preferably greater than or equal to about 12 kjoules/m², while a Class A finish. These compositions generally have a thermal conductivity greater than or equal to about 0.1 W/m-K, preferably greater than or equal to about 0.15 W/m-K, and more preferably 0.2 W/m-K.

These compositions generally have electrical volume resistivity less than or equal to about 10e⁸ ohm-cm, preferably less than or equal to about 10e⁶ ohm-cm, more preferably less than or equal to about 10e⁵ ohm-cm, and most preferably less than or equal to about 10e⁴ ohm-cm, while the surface resistivity is greater than or equal to about 10e⁸ ohm-cm, preferably greater than or equal to about 10e⁹ ohm-cm, and more preferably greater than or equal to about 10e¹⁰ ohm-cm. These compositions generally conduct electricity through an electric transport mechanism, which is ballistic in nature, i.e., wherein the resistivity does not vary proportionally with the length of the conductive elements. Such compositions may be advantageously utilized in automotive body panels, electrostatically dissipative films for packaging, electromagnetically shielding panels for electronics, avionics, and the like. They may also be used in chip trays, thermally conductive panels, biomedical applications, high strength fibers, hydrogen storage devices for use in fuel cells, and the like.

### EXAMPLE 7

This experiment was performed to demonstrate that conductive networks formed in an electrically conductive composition can be improved by thermal annealing to produce even better electrically conductive composites. In this example, HF 1110, a polycarbonate resin was melt blended with SWNT's containing 10 wt % impurities. The compositions are shown in the Table 11. Table 11 reflects the electrical resistivity in ohm-cm for the samples after extrusion into strands, injection molding and after annealing at 220° C. in an oven. The samples were extruded on a 30 mm Twin Screw Extruder, while the injection molded samples were manufactured on a 85 ton van Dorn molding machine. The annealed samples were treated to 220° C. for a time periods of 120 minutes.

TABLE 11

| | | | | |
|---|---|---|---|---|
| | | | | Volume Resistivity |
| Sample No. | % SWNT | PC | Form | (Ohm-cm) |

Electrical Resistivity Measured After Extrusion/Molding

| | | | | |
|---|---|---|---|---|
| 1 | 1 | HF 1110 | Strand | 9.9 × 10⁴ |
| 2 | 1 | HF 1110 | Molded Part | — |
| 3 | 2 | HF 1110 | Strand | 8.70 × 10² |
| 4 | 2 | HF 1110 | Molded Part | 2.56 × 10⁶ |

Electrical Resistivity Measured After Annealing

| | | | | |
|---|---|---|---|---|
| 5 | 1 | HF 1110 | Strand | 1.34 × 10³ |
| 6 | 1 | HF 1110 | Molded Part | 1.12 × 10³ |
| 7 | 2 | HF 1110 | Strand | 1.24 × 10² |
| 8 | 2 | HF 1110 | Molded Part | 3.96 × 10² |

From the Table 11, it may be seen that for the composition containing 1 wt % and 2 wt % SWNT (Sample Nos. 1 to 4), the extruded sample is more conductive than the injection molded samples. In other words, the mode of processing plays an important role in the electrical conductivity of the sample. However, upon annealing the samples at 220° C., the electrical conductivity of all the samples improved (i.e., increased) as may be seen for Sample Nos. 5 to 8 in Table 11. Further, it may be seen that the annealed samples do not exhibit as significant a difference in electrical conductivity depending upon the mode of processing. In other words, annealing appears to erase any traces of processing. Without being limited by theroy it is believed that the thermal motion induced by annealing above the glass transition temperature promotes a small rearrangement of the SWNTs, which improves the electrical conductivity. This improvement in electrical conductivity may be brought about an increase in the number of SWNTs participating in the established network in the composition.

### EXAMPLE 8

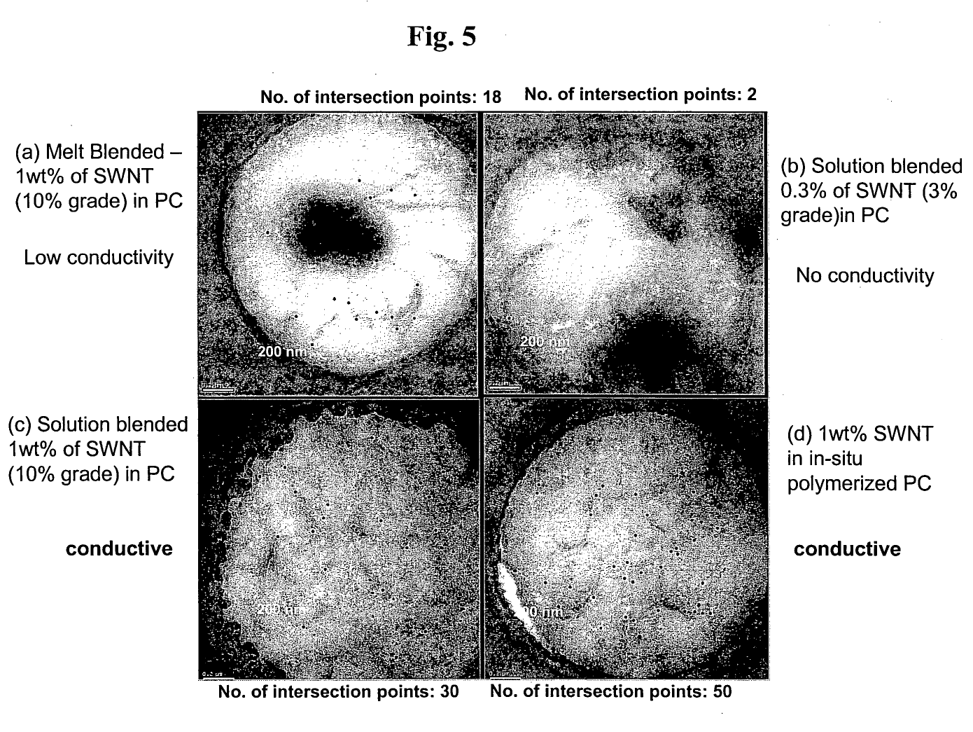

This example was performed to demonstrate that the presence of network nodes in the conductive composition facilitates electrical conductivity. The conductive composition comprising polycarbonate (obtained from General Electric) and SWNTs were either melt blended or solution blended as may be seen in the FIG. 5. FIG. 5 displays photomicrographs of the microtomed sections of samples taken from the conductive compositions as seen under a transmission electron microscope (TEM). The microtomed sections were optimally etched with a solvent, enabling imaging of the SWNT ropes dispersed in the polymer matrix. In FIG. 5, it may be seen that the samples containing the larger number of nodes, indicated by the black spots, generally display a better electrical conductivity. For example, the photomicrograph (b) shows no black spots and consequently the sample displays no electrical conductivity. On the other hand, photomicrographs (c) and (d) show about 30 and 50 black spots (nodes) and these samples show a higher conductivity than those displayed by the samples shown in photomicrographs (a) and (b) respectively. From these results, it is clearly seen that by increasing the number of nodes, an increase in the electrical conductivity can be brought about. It is therefore desirable to increase the number of nodes per square micrometer.

### EXAMPLE 9

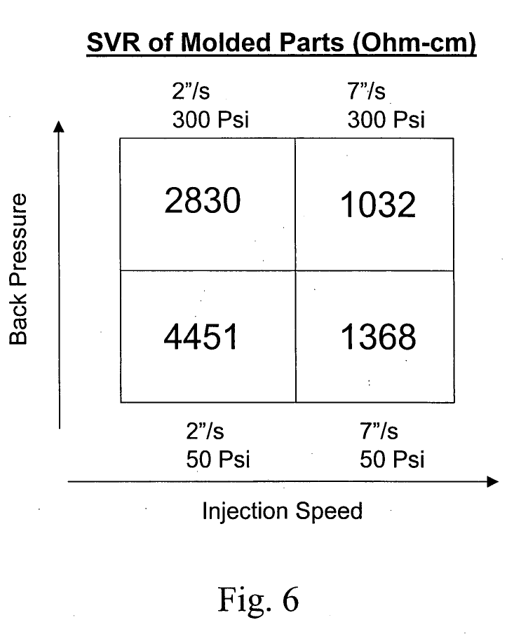

This example was undertaken to demonstrate that electrical conductivity can be improved by varying the molding conditions. In this example, polycarbonate was used as the polymeric resin, while SWNT's containing 10 wt % impurities were used to form the electrically conductive network. Standard tensile bars were injection molded in a 85 Ton van Dorn injection molding machine. The bars were tested as described in the earlier examples. The results are shown in the FIG. 6. FIG. 6 shows how specific volume resistivity (SVR) varies with the speed of injection. From the figure, it may be seen that as back pressure and speed of injection are increased, there is a decrease in electrical resistivity. This clearly shows that the network can be improved in order to improve the electrical conductivity of the molded part. As noted earlier, increasing the mold temperature and the residence time in the mold may also increase the electrical conductivity of the molded part.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electrically conductive composition comprising:
a polymeric resin; and
single wall carbon nanotubes, wherein the composition has an electrical volume resistivity less than or equal to about 10e¹² ohm-cm, a notched Izod impact strength greater than or equal to about 5 kilojoules/square meter.

2. The composition of claim 1, wherein the composition has an electrical volume resistivity less than or equal to about 10e⁸ ohm-cm, a notched Izod impact strength greater than or equal to about 5 kilojoules/square meter.

3. The composition of claim 1, wherein the single wall carbon nanotubes have diameters of about 0.7 to about 2.4 nanometers.

4. The composition of claim 1, wherein the carbon nanotubes have an inherent electrical conductivity of about 10⁴ Siemens/centimeter.

5. The composition of claim 1, wherein the carbon nanotubes have an inherent thermal conductivity of at least about 2000 Watts/meter-Kelvin.

6. The composition of claim 1, wherein the carbon nanotubes have a tensile strength of at least about 80 Gigapascals, and a stiffness of at least about 0.5 Tarapascals.

7. The composition of claim 1, wherein the composition has an electron-transport mechanism that is ballistic.

8. The composition of claim 1, wherein the carbon nanotubes exist in the form of ropes of at least about 10 carbon nanotubes.

9. The composition of claim 1, wherein the carbon nanotubes exist in the form of ropes of at least about 100 carbon nanotubes.

10. The composition of claim 1, wherein the carbon nanotubes exist in the form of ropes of at least about 1000 carbon nanotubes.

11. The composition of claim 1, wherein the carbon nanotubes exist in the form of ropes of at least about 10000 carbon nanotubes.

12. The composition of claim 1, wherein the carbon nanotubes comprise up to about 10 wt % impurities, wherein the impurities are iron, iron oxides, yttrium, cadmium, nickel, cobalt, copper, soot, amorphous carbon, multi-wall carbon nanotubes, or combinations comprising at least one of the foregoing impurities.

13. The composition of claim 1, wherein the carbon nanotubes comprise up to about 80 wt % impurities, wherein the impurities are iron, iron oxides, yttrium, cadmium, nickel, cobalt, copper, soot, amorphous carbon, multi-wall carbon nanotubes, or combinations comprising at least one of the foregoing impurities.

14. The composition of claim 1, wherein the carbon nanotubes are metallic, semi-conducting, or combinations comprising at least one of the foregoing carbon nanotubes.

15. The composition of claim 13, wherein the carbon nanotubes comprise about 1 to about 99.99 wt % metallic carbon nanotubes.

16. The composition of claim 13, wherein the carbon nanotubes comprise about 1 to about 99.99 wt % semi-conducting carbon nanotubes.

17. The composition of claim 1, wherein the nanotubes are armchair nanotubes, zigzag nanotubes, or combinations comprising at least one of the foregoing nanotubes.

18. The composition of claim 13, wherein the carbon nanotubes comprise about 1 to about 80 wt % impurities.

19. The composition of claim 1, comprising carbon nanotubes in an amount of less than or equal to about 2 wt % and wherein the composition has an electrical volume resistivity less than 10e⁶ ohm-cm, and a notched Izod impact strength greater than 5 kilojoules/square meter.

20. The composition of claim 1, wherein the polymeric resin is semi-crystalline and comprises spherulites having single wall carbon nanotubes contained therein.

21. The composition of claim 1, wherein the polymeric resin has a crystallinity of greater than or equal to about 5 wt %, based on the total weight of the composition.

22. The composition of claim 21, having an enthalpy of melting greater than or equal to about 0.2 Joules/mole Kelvin when measured in a differential scanning calorimeter at a rate of 2° C./minute.

23. The composition of claim 21, wherein the semi-crystalline polymeric resin comprises crystals oriented in the azimuthal direction of about θ=0 degrees to about θ=80 degrees.

24. The composition of claim 21, wherein the crystals have a shish kebab structure.

25. The composition of claim 21, wherein the composition has crystals having a biaxial orientation.

26. The composition of claim 21, wherein a single wall nanotube behaves as a nucleating agent and wherein at least 1 wt % of the crystals are nucleated upon the single wall carbon nanotubes.

27. The composition of claim 21, comprising about 0.001 to about 90 wt % single wall carbon nanotubes and about 10 to about 99.999 wt % of the semi-crystalline polymeric resin.

28. The composition of claim 1, wherein the composition comprises an amorphous resin in an amount of about 10 to about 99.99 wt %.

29. The composition of claim 1, wherein the polymeric resin is a polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones or combinations comprising at least one of the foregoing polymeric resins.

30. The composition of claim 1, having a thermal conductivity greater than or equal to about 0.2 W/m-K.

31. The composition of claim 1, having a tensile strength greater than or equal to about 562 kg/cm² and a Class A surface finish.

32. The composition of claim 1, wherein the polymeric resin is has a molecular weight from about 1000 g/mole to about 1,000,000 g/mole.

33. The composition of claim 1, wherein the polymeric resin is a blend of polymers, a copolymer, a terpolymer or combinations comprising at least one of the foregoing polymeric resins.

34. The composition of claim 33, wherein the polymeric resin has a phase separated morphology and wherein a substantial proportion of the single wall carbon nanotubes are present in a single phase of the blend.

35. The composition of claim 1, wherein the single wall carbon nanotubes are derivatized with functional groups.

36. The composition of claim 34, wherein the single wall carbon nanotubes are derivatized with functional groups either on a side-wall or on a hemispherical end.

37. The composition of claim 1, wherein the single wall carbon nanotubes have no hemispherical ends attached thereto or have at least one hemispherical end attached thereto.

38. An electrically conductive composition comprising:
a polymeric resin; and
multiwall carbon nanotubes, wherein the multiwall carbon nanotubes have a diameter of less than 3.5 nanometers, and wherein the composition has an electrical volume resistivity less than or equal to about 10e¹² ohm-cm, a notched Izod impact strength greater than or equal to about 5 kilojoules/square meter.

39. The composition of claim 38, wherein the composition has an electrical volume resistivity of less than or equal to about 10e⁸ ohm-cm, a notched Izod impact strength greater than or equal to about 5 kilojoules/square meter.

40. The composition of claim 38, wherein the multiwall carbon nanotubes have two, three, four or five walls of carbon.

41. A method for manufacturing a composition comprising:
blending a polymeric resin and single wall carbon nanotubes, to produce a composition having an electrical volume resistivity of less than or equal to about 10e⁸ ohm-cm, a notched Izod impact strength greater than or equal to about 5 kilojoules/square meter.

42. The method of claim 41, wherein the single-wall carbon nanotubes are added to the polymeric resin in the form of a non-electrically conductive masterbatch comprising at least 3 wt % carbon nanotubes.

43. The method of claim 42, wherein the masterbatch comprises a semi-crystalline polymer or an amorphous polymer, and wherein the masterbatch has a resistivity of greater than, less than, or equal to the resistivity of the conductive composition.

44. The method of claim 41, wherein the blending comprises melt blending, solution blending or combinations comprising at least one of the foregoing methods of blending.

45. The method of claim 41, wherein the polymeric resin is synthesized from monomers, dimers, trimers or combinations comprising at least one of the foregoing monomers, dimers or trimers during the process of blending.

46. The method of claim 45, wherein the single wall carbon nanotubes are sonicated in the presence of the monomer prior to the polymerization of the polymer.

47. The method of claim 41, wherein the polymeric resin is semi-crystalline or amorphous and has a molecular weight of about 100 g/mole to about 1,000,000 g/mole.

48. The method of claim 41, wherein the blending of the composition involves the use of shear force, extensional force, compressive force, ultrasonic energy, electromagnetic energy, thermal energy or combinations comprising at least one of the foregoing forces and energies and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, screen packs, rolls, rams, helical rotors, or combinations comprising at least one of the foregoing.

49. The method of claim 41, wherein the blending comprises extrusion and wherein the single wall carbon nanotubes are fed downstream as a masterbatch during extrusion.

50. The method of claim 41, wherein the composition is further subjected to ultradrawing in the unaxial direction utilizing draw ratios of about 2 to about 1,000,000.

51. The method of claim 41, wherein the composition is further stressed uniaxially or biaxially to produce a film having a thickness of about 0.01 micrometers to about 5000 micrometers.

52. The method of claim 41, wherein the composition is further supercooled to a temperature of about 1° C. to about 100° C. below the melting point after the blending for a time period of about 2 minutes to about 2 hours.

53. The method of claim 41, wherein the blending comprises melt blending or solution blending, and wherein the blending utilizes a fluid in the liquid state, the gaseous state, the supercritical state or combinations comprising at least one of the foregoing states.

54. The method of claim 41, wherein the specific energy utilized for the blending is an amount of about 0.01 kwhr/kg to about 10 kwhr/kg.

55. The method of claim 41, further comprising forming the composition in processes comprising injection molding, compression molding, blow molding or vacuum forming.

56. The method of claim 41, wherein the composition has an electrical volume resistivity less than or equal to about 10e¹² ohm-cm and a Class A surface finish.

57. The method of claim 41, further comprising annealing the composition at a temperature of greater than or equal to about the glass transition temperature of the polymeric resin.

58. The method of claim 41, wherein the composition comprises a single wall carbon nanotube network having an amount of greater than or equal to about 5 nodes/square micrometer.

59. An article manufactured from the composition of claim 1.

60. An article manufactured from the composition of claim 38.

61. An article manufactured by the method of claim 41.
